(19) United States
(12) Patent Application Publication
(10) Pub. No.: US 2008/0291578 A1
(43) Pub. Date: Nov. 27, 2008

(54) SUBSTRATE, MAGNETIC RECORDING MEDIUM AND MANUFACTURING METHOD THEREOF, AND MAGNETIC STORAGE APPARATUS

(75) Inventors: Masaru Ono, Higashine (JP); Yuki Yoshida, Higashine (JP); Kiyoshi Yamaguchi, Higashine (JP); Akira Kikuchi, Higashine (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/123,173

(22) Filed: May 19, 2008

(30) Foreign Application Priority Data
May 22, 2007 (JP) 2007-135472

(51) Int. Cl. G11B 5/33; G11B 5/62; B32B 3/00; B05D 3/12

(52) U.S. Cl. 360/313; 428/141; 428/846; 427/129

(57) ABSTRACT

This perpendicular magnetic recording medium has a nonmagnetic substrate and a magnetic recording structure formed above the substrate. The magnetic recording structure has at least a soft magnetic underlayer, an intermediate layer and a magnetic layer. The substrate has a surface profile curve whose angle of inclination is 2.0 degree or less, or whose surface roughness of the substrate, with cycle (wavelength components) in the ranges of 83 nm or less to 30 nm or less, is 0.15 nm or less.

### BACKGROUND OF THE INVENTION

1. Field of the Invention

The embodiments discussed herein are directed to a substrate, a magnetic recording medium and a manufacturing method thereof, and a magnetic storage apparatus, and more specifically to substrates suitable for a perpendicular magnetic recording medium, perpendicular magnetic recording mediums and the manufacturing method thereof, and magnetic storage apparatus having the perpendicular magnetic recording medium.

2. Description of Related Art

With the development of information processing technology, a magnetic storage apparatus used as an external storage apparatus of a computer is required having high performance such as high-capacity and high speed transfer. To this end, the perpendicular recording medium has been developed in order to achieve magnetic recording with high recording density in recent years.

The noise generated from a recording layer (or a magnetic layer) can be reduced enough to realize the high recording density in longitudinal magnetic recording layers. This applies to the typical perpendicular magnetic recording medium. Conventionally, the noise had been reduced by decreasing a surface roughness Ra of a substrate.

FIG. 1 shows a relationship between a Ru (002) rocking Δθ₅₀ (degree) and a surface roughness Ra of the substrate of the typical perpendicular magnetic recording medium. The characteristics shown in FIG. 1 are indicated with actual measurement values of the perpendicular magnetic recording medium with a structure composed of a soft magnetic underlayer made of a 35 nm thickness of CoFe alloy, an intermediate layer with a FCC (Face-Centered Cubic lattice) structure made of 5 nm of Ni alloy, an intermediate layer made of a 20 nm thickness of Ru, a granular oxide layer made of a 10 nm thickness of CoCrPt—TiO₂ wherein oxides segregates magnetic grains each other, a magnetic layer made of a 10 nm thickness of CoCrPtB alloy, a protective layer made of a 4 nm thickness of diamond-like carbon (DLC) and a 1 nm thickness of a lubricant layer on a chemical strengthening glass substrate. In FIG. 1, a vertical axis indicates variances of crystal axes in the Ru intermediate layer, and a horizontal axis indicates mean surface roughness of a 3-D image of the substrate surface in a field of view of 1 μm×1 μm sq. under an atomic force microscope (AFM). In other words, the vertical axis indicates a half-value width Δθ₅₀ of XRD (X-Ray Diffraction) rocking curve, and the horizontal axis indicates a surface roughness Ra, respectively. As shown in FIG. 1, the noise generated from the magnetic layer is reduced as Δθ₅₀ decreases.

A conventional method for a mirror-like finishing of the substrate surface with a tape is discussed in Japanese Laid-open Patent Publication 1994-203371. A conventional method for texturing the substrate in a circumferential direction is discussed in Japanese Laid-open Patent Publication 2004-280961. A conventional method for adjusting the surface roughness of the substrate by plating is discussed in Japanese Laid-open Patent Publication 2004-342294.

In regions on the substrate where the surface roughness Ra is less than 0.4 nm (FIG. 1), the noise reduction by decreasing surface roughness Ra is less effective. For that reason, further noise reduction of the perpendicular magnetic recording medium is difficult by decreasing the surface roughness Ra alone.

### SUMMARY OF THE INVENTION

In accordance with an aspect of an embodiment, a perpendicular magnetic recording medium has a nonmagnetic substrate and a magnetic recording structure formed above the substrate. The magnetic recording structure is formed by at least a soft magnetic underlayer, an intermediate layer and a magnetic layer. The substrate has a surface profile curve whose angle of inclination is 2.0 degree or less, or whose surface roughness, with frequency components having wavelengths (hereafter cycles) in the ranges of 83 nm or less to 30 nm or less, is 0.15 nm or less.

### BRIEF DESCRIPTION OF THE DRAWINGS

The present invention will be explained with reference to the accompanying drawings.

FIG. 1 shows a relationship between a Ru (002) rocking Δθ₅₀ (degree) and a surface roughness Ra of a substrate of a conventional perpendicular magnetic recording medium.

FIG. 2A is a sectional diagram of the conventional substrate, indicating the angle of inclination of the surface thereof.

FIG. 2B is a sectional diagram of the substrates in one embodiment of this invention, indicating the angle of inclination of the surface thereof.

FIG. 3 shows a calculation method of the angle of inclination.

FIG. 4 shows results of an investigated correlativity of the surface roughness Ra of the substrate and the noise.

FIG. 5 shows results of an investigated correlativity of the angle of inclination and the noise.

FIG. 6 shows results of substrate evaluations.

FIG. 7 is a perspective view explaining a substrate processing.

FIG. 8 is a sectional diagram of the magnetic recording medium in one embodiment of this invention.

FIG. 9 shows characteristics of samples of the perpendicular magnetic recording medium of this invention.

FIG. 10 shows frequency analysis results on actual measurement values of the surface roughness Ra with the cycle in the ranges of 100 nm or less to 20 nm or less of the samples shown in FIG. 9.

FIG. 11 shows an analysis result of a correlation coefficient derived from measuring actual values of the surface roughness Ra with the cycle in the ranges of 100 nm or less to 20 nm or less in a X axis direction, the angle of inclination in a Y axis direction and actual measurement values of Δθ₅₀.

FIG. 12 shows a relationship between the correlation coefficient and the surface roughness Ra with the cycle in the ranges of 10 nm or less to 20 nm or less in terms of the angle of inclination and values of Δθ₅₀ based on the analyses results shown in FIG. 10 and FIG. 11.

FIG. 13 shows the correlativities between the angles of inclination, the values of Δθ₅₀, the values of the VMM2L, the surface roughness Ra and the surface roughness Ra with the cycle in the ranges of 100 nm or less to 20 nm or less.

FIG. 14 is a sectional view illustrating part of a magnetic storage apparatus in one embodiment of this invention.

FIG. 15 is a plan view illustrating part of the magnetic storage apparatus in one embodiment of this invention.

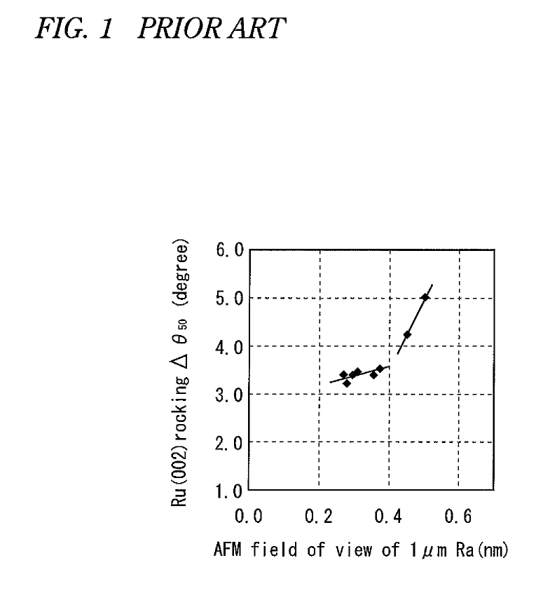

### DETAILED DESCRIPTION

Embodiments of the present invention will be described in detail below with reference to the accompanying drawings.

The inventors of this invention have found a correlation between a shape indication of the substrate surface and the noise generated from a perpendicular magnetic recording medium. A perpendicular magnetic recording medium wherein the noise generated from the recording layer is reduced can be realized by mechanically processing (e.g., polishing) a surface of a nonmagnetic substrate so as to satisfy the appropriate shape indication. The mechanical processing is performed on the perpendicular magnetic recording medium along a track direction thereof. For instance, when the perpendicular magnetic recording medium is a magnetic disk, the processing is performed on the surface of its substrate in the circumferential direction thereof.

Specifically, the angle of inclination of the surface profile curves is 2.0 degree or less, or the surface roughness with the cycle (that is, wavelength components) in the ranges of 83 nm or less to 30 nm or less is 0.15 nm or less. More preferably, the surface roughness, with the cycle in the ranges of 59 nm or less to 40 nm or less, is 0.15 nm or less. For example, the noise (generated from the perpendicular magnetic recording medium) can be reduced using a substrate in which a surface profile of the surface roughness, with the cycle in the ranges of 50 nm or less, is 0.15 nm or less.

1. Angle of Inclination:

The described embodiments use an angle of inclination which is calculated from a sectional shape profile of the substrate.

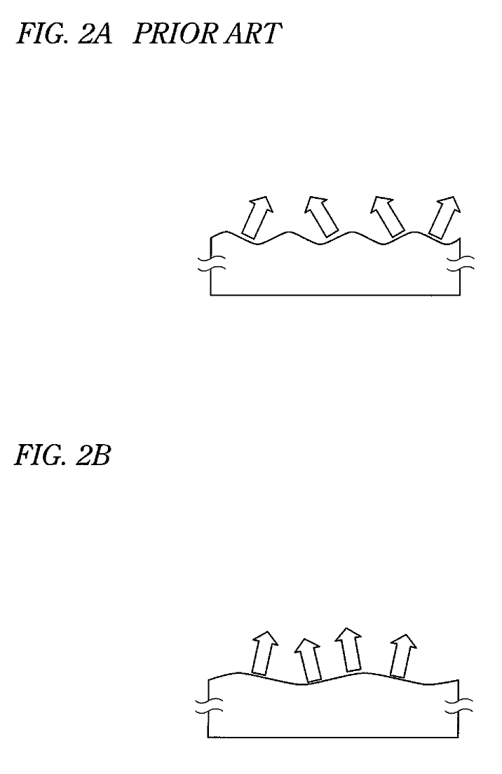

FIG. 2A is a sectional diagram of the typical substrate, indicating angle of inclination of the surface thereof. FIG. 2B is a sectional diagram of a substrate in an embodiment of this invention, indicating the angle of inclination of the surface thereof. In FIG. 2A and FIG. 2B, the surface roughness Ra is the same because the difference in height is the same. However, the angle of the inclination in FIG. 2B is less than that in FIG. 2A. In FIG. 2A and FIG. 2B, arrows indicate the variance of crystal axes in orientations in the intermediate layer formed above the substrate.

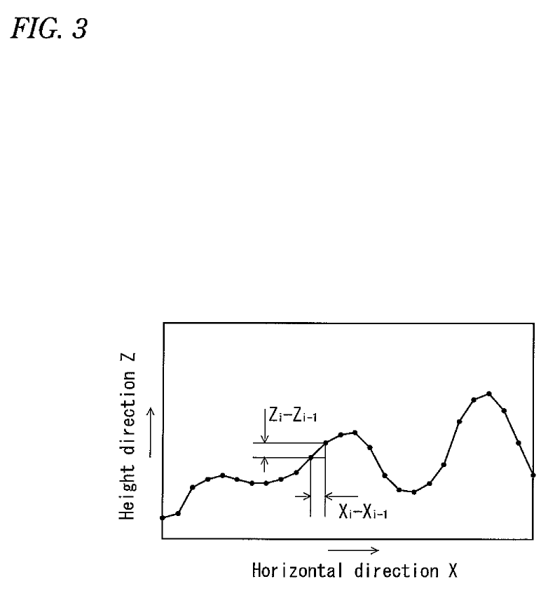

FIG. 3 shows a calculation method of the angle of inclination. In FIG. 3, the vertical axis and the horizontal axis indicate a height direction Z and a horizontal direction X of the substrate in arbitrary units, respectively. Where the number of sampling points is defined as “n” (n is an integer), the angle of inclination can be defined by following expression (1).

$$angle of inclination = \frac{{\sum }_{i = 1}^{n} \vert {tan}^{- 1} \{ \frac{{Z}_{i} - {Z}_{i - 1}}{{X}_{i} - {X}_{i - 1}} \} \vert}{L} \qquad ( 1 )$$

which indicate a mean value of all angles of inclinations on the substrate surface. Here, L can be written as the following expression (2).

$$L = {\sum }_{i = 1}^{n} ( {X}_{i} - {X}_{i - 1} ) \qquad ( 2 )$$

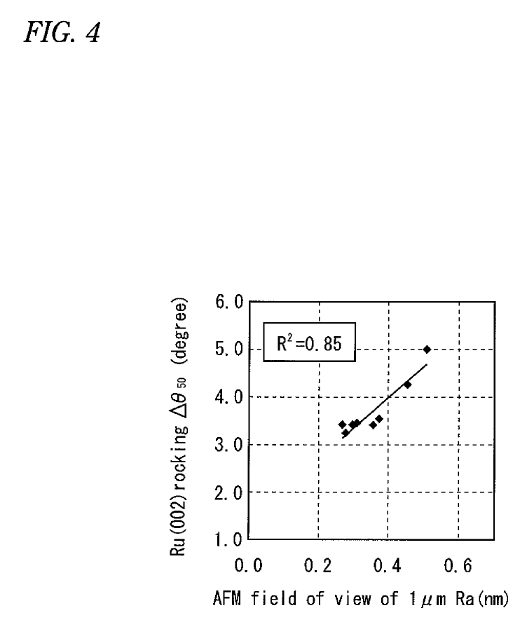

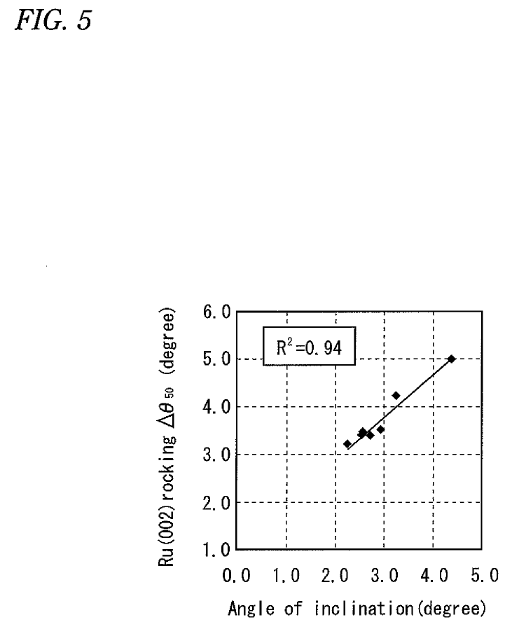

There is a correlation between the angle of inclination and the noise generated from the perpendicular magnetic recording medium. FIG. 4 shows the result of measurement on correlativity of the surface roughness of the substrate and the noise. FIG. 5 shows the results of the investigation on the correlativity of the angle of inclination and the noise. The characteristics shown in FIG. 4 and FIG. 5 are indicated with the actual measurement values of the perpendicular magnetic recording medium with a structure that had the follows layers: (1) a soft magnetic underlayer made of a 35 nm thickness of CoFe alloy; (2) an intermediate layer with a FCC structure made of 5 nm of Ni alloy; (3) an intermediate layer made of a 20 nm thickness of Ru; (4) a granular oxide layer made of a 1 nm thickness of CoCrPt—TiO₂ wherein the oxide segregates the magnetic grains; (5) a magnetic layer (or a recording layer) made of a 10 nm thickness of CoCrPtB alloy; (6) a protective layer made of a 4 nm thickness of diamond-like carbon (DLC), and (7) a 1 nm thickness of a lubricant layer on a chemical strengthening glass substrate. In FIG. 4, the perpendicular axis indicates the variance of the crystal axes in orientation, viz, the half-value width Δθ₅₀ of XRD rocking curve. The horizontal axis indicates the mean surface roughness of the 3-D image of the substrate in the field of view of 1 μm×1 μm sq. under the AFM, viz, the surface roughness Ra. In FIG. 5, the perpendicular axis indicates the variance of the crystal axes in orientation in the Ru alloy intermediate layer, viz, the half-value width Δθ₅₀ of XRD rocking curve. The horizontal axis indicates the angle of inclination. In FIG. 4, R²=0.85 expresses the correlation coefficient obtained by deriving a linear approximation by a least-squares method where the X axis indicates Ra and the Y axis indicates Δθ₅₀. In FIG. 5, R²=0.94 expresses a correlation coefficient obtained by deriving the linear approximation by the least-squares method where the X axis indicates the angle of inclination and the Y axis indicates Δθ₅₀. As FIG. 4 shows, when Ra's value is 0.4 or less, a correlation is small between the noise and the Ra. In contrast, correlation is always high between the angle of inclination and the noise. Thus, the angle of inclination has a higher correlativity with the noise than the surface roughness Ra.

Analyzing the surface of the typical substrate, the angle of inclination is greater than 2.0 degree. The typical substrate is formed to have the predetermined value of the surface roughness Ra. However, the noise reduction by decreasing the Ra on the substrate surface is less effective in a region where the surface roughness Ra is less than 0.4 nm. As such, an idea to process the surface whose surface roughness Ra is, e.g., less than 0.4 nm for a further decrease of the noise had not been conceived.

Whereas, with the embodiment described here, the noise generated from the perpendicular magnetic recording medium can be reduced by processing the surface of the substrate further to decrease the angle of inclination to 2.0 degree or less.

2. The Surface Roughness Ra in Short Cycle

The sectional shape of the substrate surface can be expressed by a summation of waveforms composed of a variety of frequency components. Of such frequency components, a waveform composed of the frequency component with a relatively long wavelength is defined as a long-cycle component. A waveform composed of a frequency component with a relatively short wavelength is defined as a short-cycle component. Roughness of the long-cycle component lightly affects the angle of inclination, but roughness of the short-cycle component heavily affects it. Therefore, the roughness of the short-cycle component can be used instead of an indication of the angle of inclination.

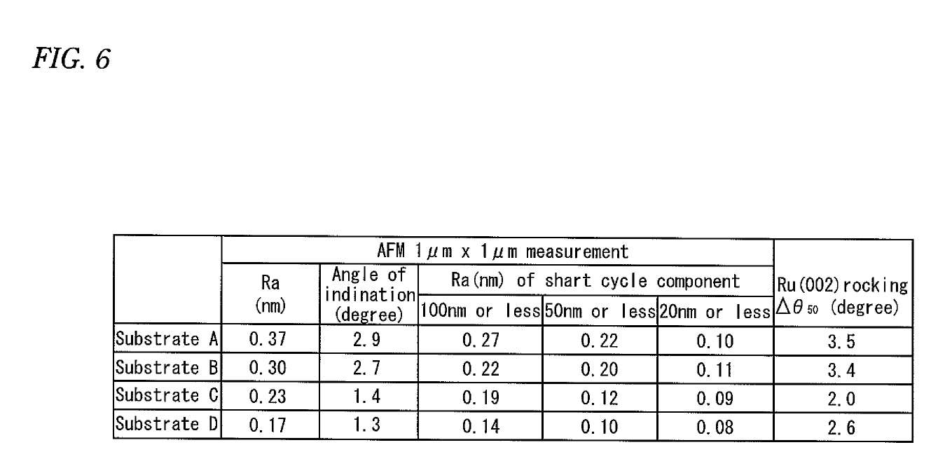

FIG. 6 shows results of substrate evaluations. In FIG. 6, a substrate A is a sample of the typical chemical strengthening glass substrate with 0.37 nm of the surface roughness Ra. A substrate B is a sample of the conventional chemical strengthening glass substrate with 0.3 nm of the surface roughness Ra. A substrate C is a sample of the substrate A processed in the circumferential direction. A substrate D is a sample of the substrate B processed in the circumferential direction.

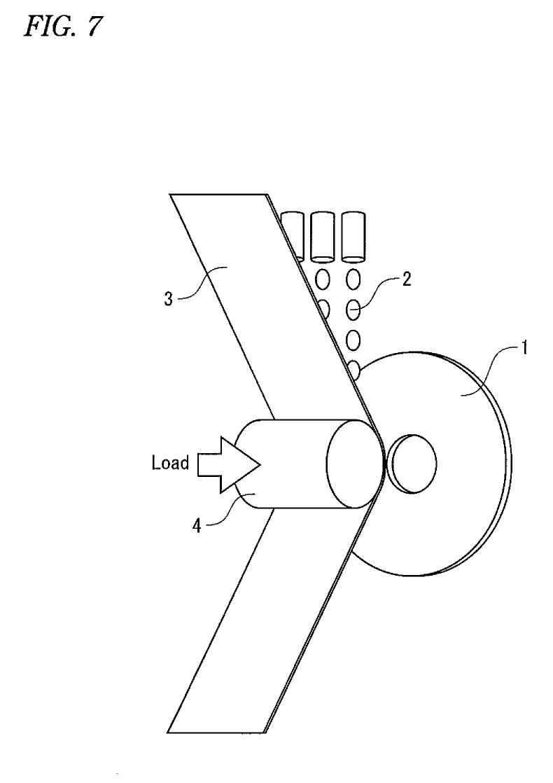

FIG. 7 is a perspective view explaining the processing of the substrates C and D. A substrate 1 to be processed has a disk-like shape. The substrate 1 is processed in the circumferential direction as per FIG. 7 by rotating it in the circumferential direction indicated with an arrow, then pressing a tape 3 made of urethane foam impregnated with diamond slurry 2 in a P direction onto a surface thereof by a gum roller 4. In this way, the surface of the substrate 1 is polished by the mechanical processing.

FIG. 6 shows the surface roughness Ra of the substrates A-D, the angle of inclination, the surface roughness with the short cycle (Rasc) elements and the variance in orientation of the crystal axes on the Ru intermediate layer. i.e., the actual values of the half-values of Δθ₅₀ of the XRD rocking curve of the perpendicular magnetic recording medium as in FIG. 4 and FIG. 5. The short cycle elements include the surface roughness Ra with the cycle in the ranges of the 100 nm or less, the surface roughness Ra with the cycle in the ranges of 50 nm or less, and the surface roughness Ra with the cycle in the ranges of the 20 nm or less.

The surface roughness Ra, the angle of inclination and the surface roughness with the short cycle elements (Ra) are obtained by observing the substrate surface in the field of view of 1 μm×1 μm sq. under the AFM. The surface roughness Ra is the mean surface roughness of a surface profile of the 3-D image in the field of view of 1 μm×1 μm sq. under the AFM. The angle of inclination is derived by: 1) extracting section profile data from the 3-D image, 2) averaging and smoothing the profile data extracted at 3 arbitrary successive points, and 3) then deriving the angle using the averaged and smoothed data and above expression of the angle of inclination. The surface roughness Ra with the 50 nm cycle or less means the surface roughness Ra of the 3-D image obtained by: 1) converting AMF 3-D data into 2-D by using 2-D Fourier transformation, 2) extracting 50 nm or less cycle data in the X/Y direction, and 3) reconverting the extracted data into 3-D data. This cycle data includes 3 kinds of parameters: a wavelength in the X direction, a wavelength in the Y direction and a power spectral density.

As shown in FIG. 6, both surface roughness Ra with 100 nm or less cycle (Ra100) and the surface roughness with 20 nm or less cycle (Ra20) do not have correlativity with the angle of inclination (i.e., noise). However, the surface roughness with 50 nm or less cycle (Ra50) indicates the same tendency of a fluctuation and a behavior of the angle of inclination (i.e., the noise). Thus, it is confirmed that the surface roughness with the 50 nm or less cycle (Ra50) can be used as an alternative indication of the angle of inclination. Furthermore, the angle of inclination can be 2.0 or less by decreasing the surface roughness with the 50 nm (Ra50) or less cycle to 0.15 nm or less, thereby reducing the noise.

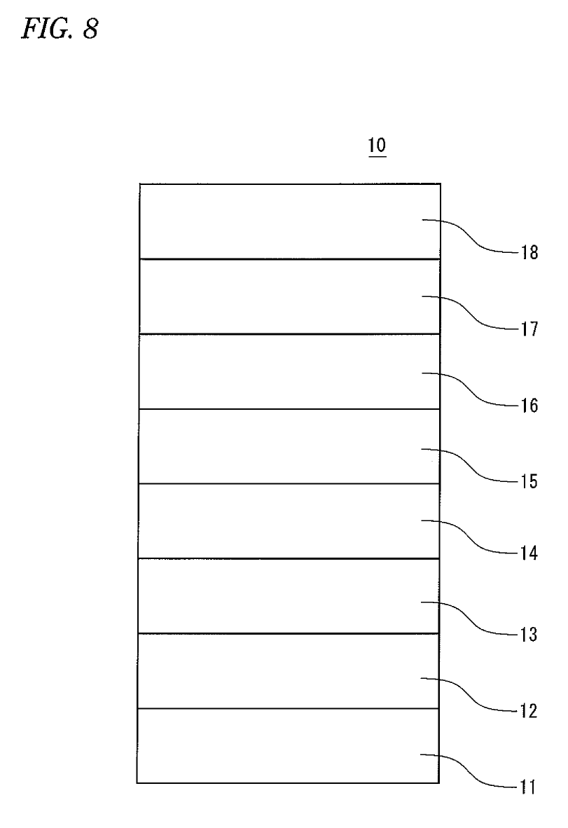

FIG. 8 is a sectional diagram of the magnetic recording medium in one of the embodiments. In this embodiment, a magnetic disk 10 is a perpendicular magnetic recording medium. The magnetic disk 10 has of the following layers: 1) a soft magnetic underlayer 12 made of a 35 nm thickness of CoFe alloy, 2) an intermediate layer 13 with a FCC structure made of a 5 nm thickness of Ni alloy, 3) an intermediate layer 14 made of a 20 nm thickness of Ru, 4) a granular oxide layer 15 made of a 10 nm thickness of CoCrPt—TiO₂ alloy wherein the oxide segregates the magnetic grains, 5) a magnetic layer 16 made of a 10 nm thickness of CoCrPtB alloy, 6) a protective layer 17 made of a 4 nm thickness of the DLC and a 1 nm thickness of a lubricant layer 18 on a substrate 11 made of chemical strengthening glass. The angle of inclination on a surface of its substrate 11 is 2.0 or less, or its substrate 11 has a surface roughness, with the 50 nm or less cycle (Ra50) of 0.15 nm or less of a surface profile. The material of the substrate 11 is not limited to the chemical strengthening glass, but also can be other nonmagnetic materials. For example, the substrate 11 can have Al and NiP thereon or glass and metal thereon. Thus, the substrate 11 is not limited to a single layer structure, but also can have a multilayer structure. Additionally, thicknesses and materials and a magnetic structure of other layers 12-18 are not considered to be limited to what is described above.

Moreover, a magnetic recording structure formed above the substrate 11 that is composed of the soft magnetic underlayer 12, the intermediate layers 13 and 14, the granular oxide layer 15 and the magnetic layer 16 is not limited to the structure shown in FIG. 8, but also can be other magnetic recording structure enabling the perpendicular magnetic recording.

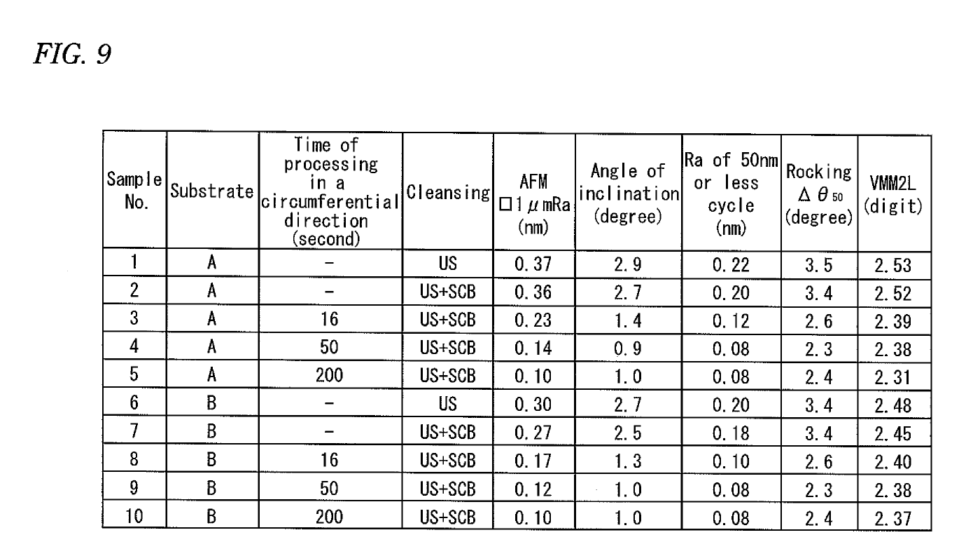

FIG. 9 shows characteristics of samples of perpendicular magnetic recording mediums. The samples listed here are: 1) the chemical strengthening glass substrates A and B with different surface roughness, not processed in the circumferential direction, and 2) the chemical strengthening glass substrates A and B with different surface roughness, processed in the circumferential direction for 16, 50 and 200 sec, respectively. The processing in the circumferential direction is performed by: 1) rotating the substrate 1 in the circumferential direction, and 2) pressing the tape 3 made of urethane foam impregnated with diamond slurry 2 onto a surface of the substrate 1 by the gum roller 4. The samples not processed in the circumferential direction are: cleansed by ultrasonic sound (US) not inducing a surface friction (US samples), or cleansed by US and then scrub (SRB) cleanser (US+SRB samples). The scrub cleanser used is a Clean Through KS3080 manufactured by Kao Corporation. The samples processed in the circumferential direction are cleansed by US and SRB. The substrates A (sample No. 1 and 2) are not processed in the circumferential direction. The sample No. 1 (the substrate A) was subjected to the US cleansing only and the sample No. 2 (the substrate A) was subjected to the US+SRB cleansing. The samples No. 3-5 (the substrates A) were subjected to the processing in the circumferential direction for 16, 50 and 200 sec respectively and cleansed by US then the SRB. The sample No. 6 and 7 (substrates B) were not subjected to processing in the circumferential direction. The sample No. 6 was subjected to US cleansing only. The sample No. 7 was subjected to US cleansing and then SRB cleansing. The samples No. 8-10 (substrates B) were subjected to processing in the circumferential direction for 16, 50 and 200 sec respectively.

Actual measurement values of the surface roughness Ra, angle of inclination and the surface roughness with a 50 nm or less cycle (Ra50) of the samples No. 1-10 were measured. The surface roughness Ra, the angle of inclination and the surface roughness with the 50 nm or less cycle (Ra50) were measured by viewing the field of view of 1 μm×1 μm sq. of the surface profile of the substrates under the AFM. The surface roughness Ra indicates the mean surface roughness of the 3-D image of the field of view of 1 μm×1 μm sq. of the surface profile under the AFM. The angle of inclination indicates values obtained by: extracting the surface profile data from the 3-D image, averaging and smoothing the profile data arbitrarily extracted at 3 successive points from the profile data, then calculated by the above expression for the angle of inclination using the data. The surface roughness with the 50 nm or less cycle (Ra50) indicates the mean surface roughness of the 3-D image obtained by: converting the 3-D data measured by the AFM by Fourier conversion, extracting the cycle data from the converted data in the X/Y direction, and reconverting the extracted data into the 3-D data.

On these chemical strengthening glass substrates 11 (samples No. 1-10) with different surface profiles are deposited per FIG. 8, 1) the soft magnetic underlayer 12 made of the 35 nm thickness of the CoFe alloy, 2) the intermediate layer 13 with the FCC structure made of the 5 nm thickness of the Ni alloy, 3) the intermediate layer 14 made of the 20 nm thickness of Ru, 4) the granular oxide layer 15 made of CoCrPt—TiO₂ wherein the oxide segregates the magnetic grains, 5) the magnetic layer 16 made of the 10 nm thickness of CoCrPtB alloy, 6) the protective layer 17 made of the 4 nm thickness of the DLC, and 7) the 1 nm thickness of the lubricant layer 18. As an indication of these substrates' surface profile and the variance of the crystal orientations, the half-value Δθ₅₀ of the XRD rocking curve is derived. As an indication of the error rate, the VMM2L is derived. The actual measurement values of the VMM2L are evaluated in terms of the recording density of 825 kbpi with a 130 Gbits/in²-capable TMR head for the perpendicular magnetic recording medium.

As shown in FIG. 9, processing the substrate surface in the circumferential direction decreases the angle of inclination and the surface roughness with the 50 nm or less cycle (Ra50). With the decrease, the values of Δθ₅₀ decrease, then the noise. and the value of VMM2L decrease, finally the error rate is improved.

With this embodiment, the noise generated from the recording layer can be reduced and thus high error rate characteristics can be obtained. Therefore, it is possible to provide the perpendicular magnetic recording medium that is suitable for high recording density.

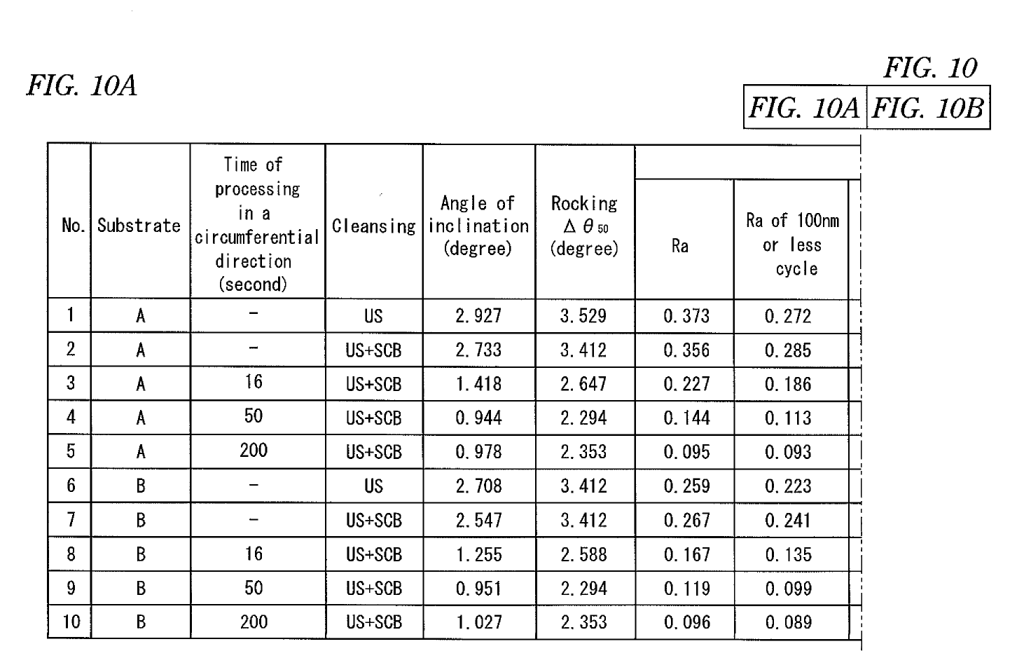

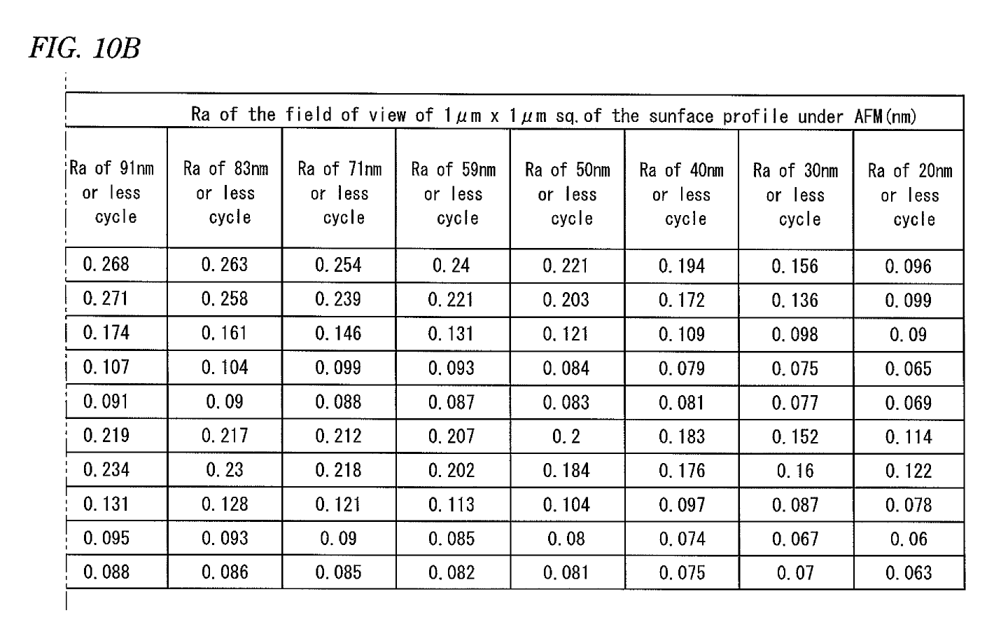

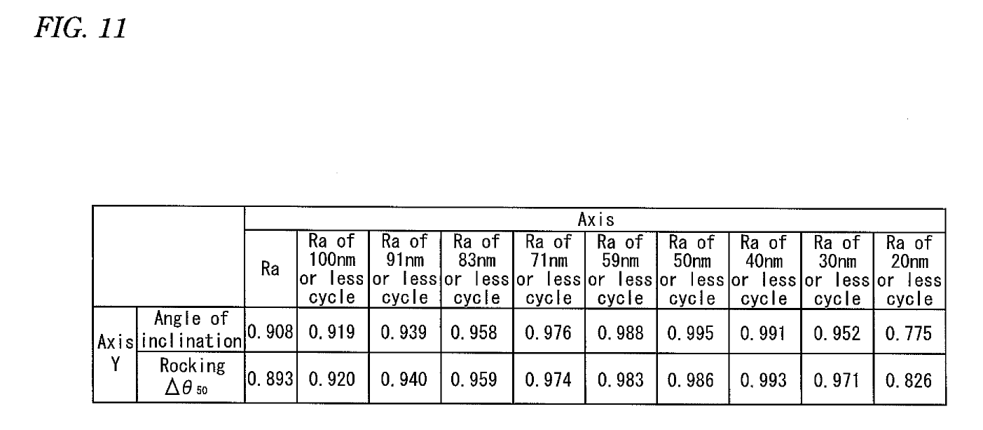

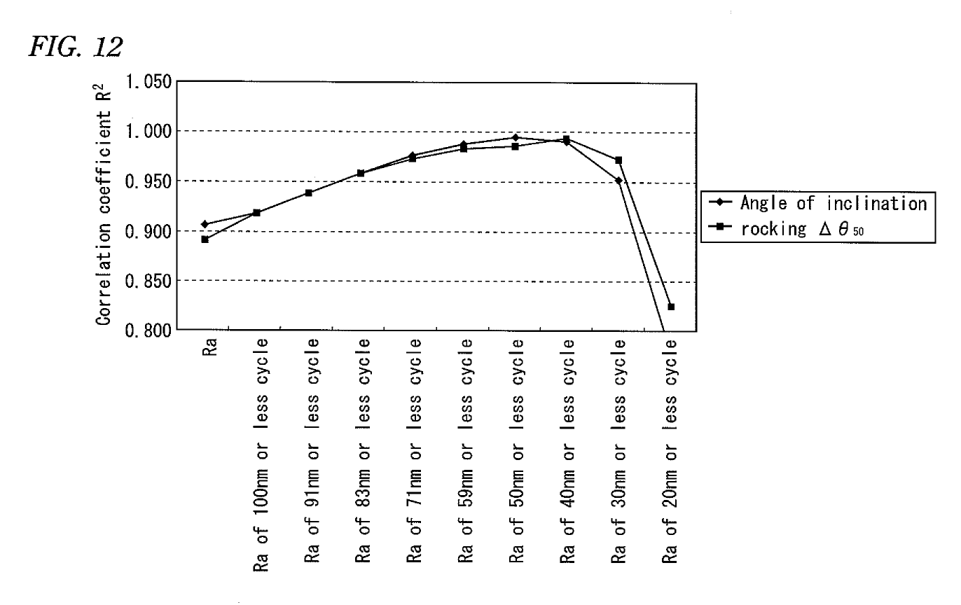

FIG. 10 shows the frequency analysis results on the actual measurement values of the surface roughness (100 nm-20 nm cycle) of the samples No. 1-10 shown in FIG. 9. FIG. 11 shows the analyses results of the correlation coefficient R² which is used in determining the surface roughness Ra with the cycle in the ranges of 100 nm or less to 20 nm or less in the X axis direction, the angle of inclination in the Y axis direction and the actual measurement values of Δθ₅₀. FIG. 12 shows a relationship between the correlation coefficients R² and the surface roughness Ra with the cycle in the ranges of 100 nm or less to 20 nm or less in terms of the angle of inclination and the value of Δθ₅₀ based on the analyses results shown in FIG. 10 and FIG. 11. In FIG. 12, data denoted with rhombic marks indicates the angle of inclination and data denoted with square marks indicates the values of Δθ₅₀. The actual values shown in FIG. 10-12 were determined under the same condition of FIG. 9.

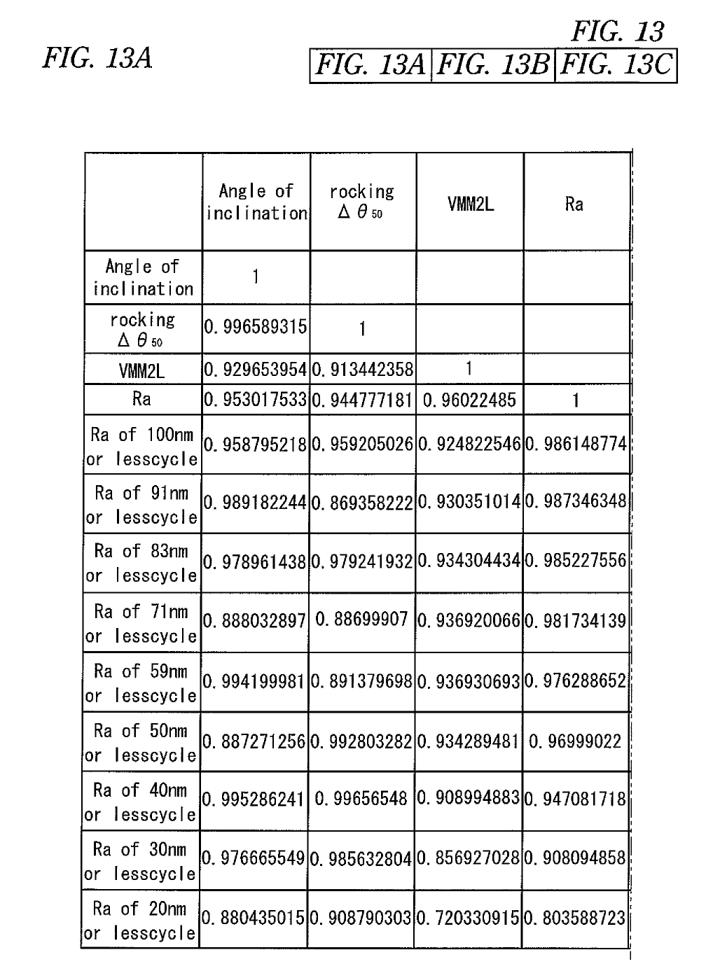

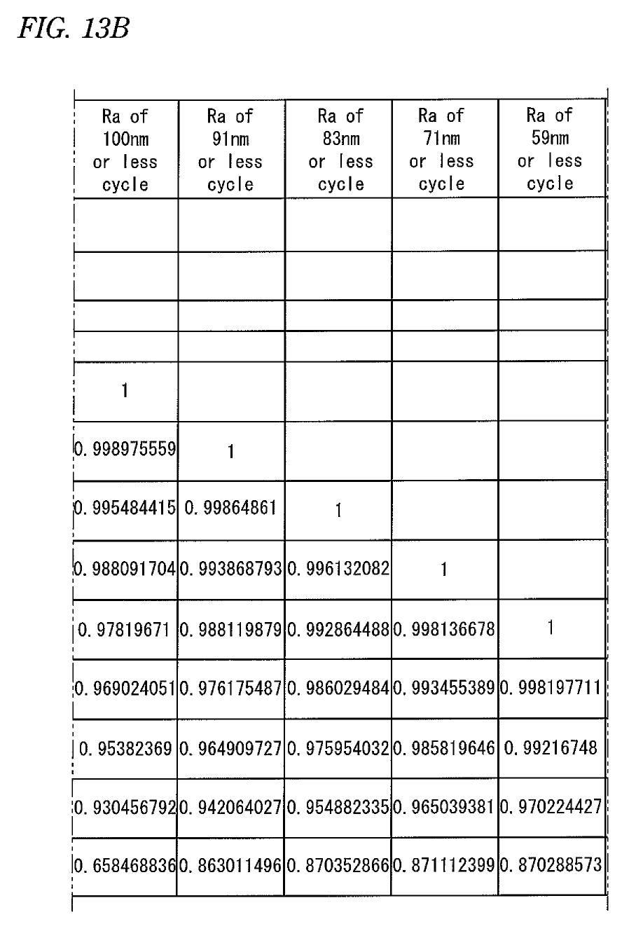

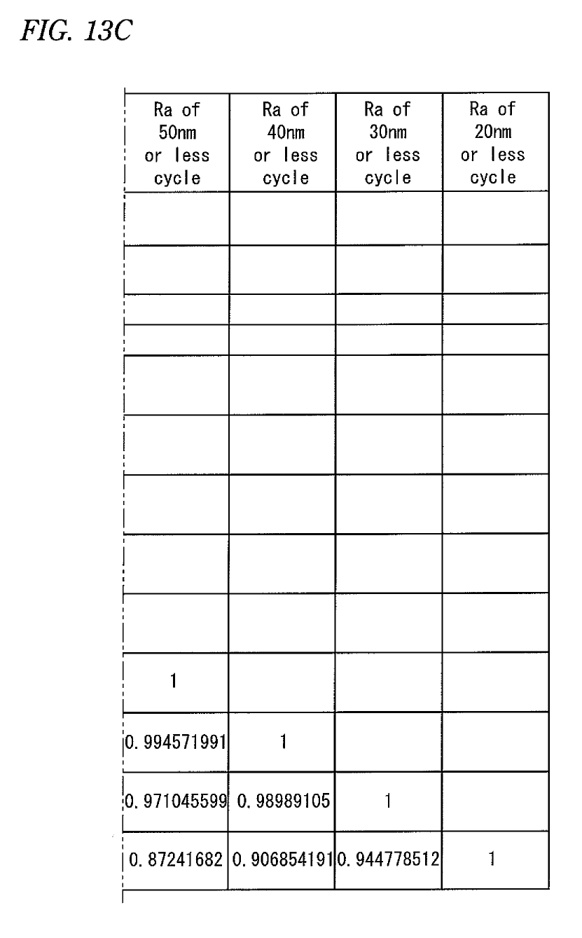

FIG. 13 shows the relationships between the angles of inclination, the values of Δθ₅₀, the values of the VMM2L, the surface roughness Ra and the surface roughness Ra with the cycle in the ranges of 100 nm or less to 20 nm or less. The actual values of the VMM2L are evaluated in terms of the 825 kbpi recording density with the 130 bits/in²-capable TMR head for the perpendicular magnetic recording medium. As per FIG. 13, with the surface roughness produced by the cycle in the ranges of 83 nm or less to 30 nm or less, the value of the correlation coefficient R² of the angle of inclination or the values of Δθ₅₀ is 0.95 or greater, which is in virtually the same correlation of the angle of inclination. Particularly, with the surface roughness produced by the cycle in the ranges of 59 nm or less to 40 nm or less, the value of the correlation coefficient R² is 0.99 or greater. It was confirmed that the surface roughness produced by the cycle in these ranges is useful for an indication of the substrate flatness instead of the angle of inclination. That is to say, where the surface profile is 0.15 nm or less with the surface roughness produced by the cycle in the ranges of 83 nm or less to 30 nm or less, (more preferably, where the surface profile is 0.15 or less with the surface roughness produced by the cycle in the ranges of 59 nm or less to 40 nm or less) the surface roughness Ra in this ranges are the virtually the same values of the angle of inclination, 2.0 or less.

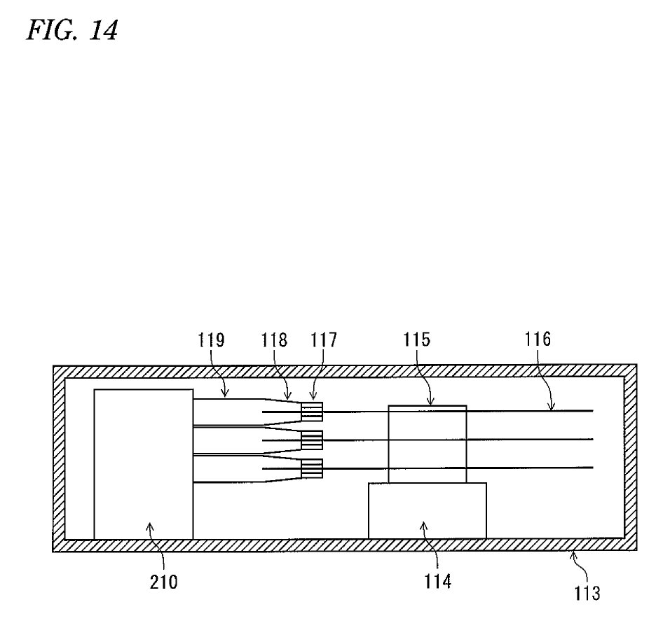

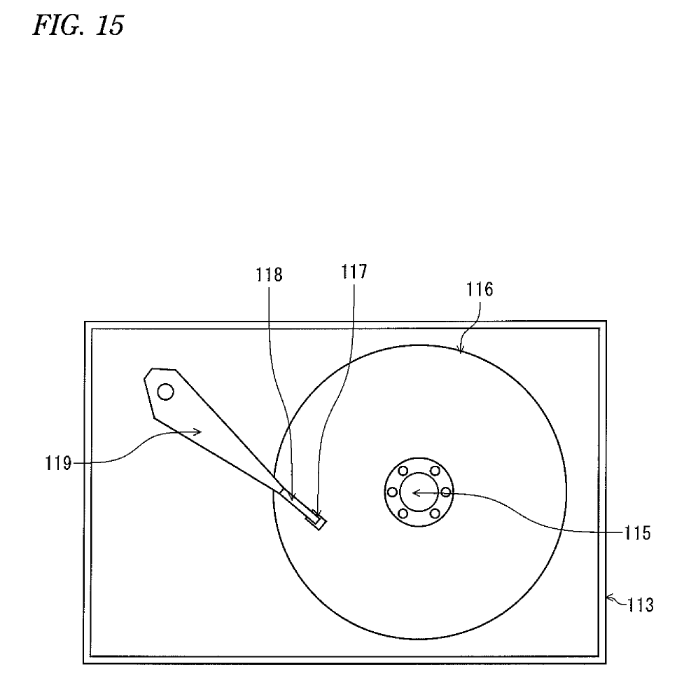

Next, one of the embodiments of the magnetic storage apparatus will be described in detail below with reference to FIG. 14 and FIG. 15. FIG. 14 is a sectional view illustrating part of the magnetic storage apparatus in one embodiment of this invention. FIG. 15 is a plan view illustrating part of the magnetic storage apparatus in one embodiment of this invention.

As FIG. 14 and FIG. 15 show, the magnetic storage apparatus has the motor 114, the hub 115, a plurality of the magnetic recording media 116, a plurality of the writing/reading heads 117, a plurality of the suspensions 118, a plurality of the arms 119 and the actuator 210 located in the housing 113. The magnetic recording media 116 are fixed on the hub 115 rotated by the motor 114. The writing/reading head 117 has the reading head and the writing head. Each writing/reading head 117 is attached to the corresponding arm 119 via the suspension 118. The arms 119 are operated by the actuator 210. The basic structure of such magnetic storage apparatus has been publically known, thus the description of it is omitted.

In this embodiment, the magnetic storage apparatus is characterized by its magnetic recording media 116. Respective magnetic recording media 116 have the structure presented in the embodiment described with reference to FIG. 2B and FIG. 3-13. The number of the magnetic recording media 116 is not considered to be limited to 3.

The structure of the magnetic storage apparatus is not limited to the ones shown in FIG. 14 and FIG. 15. In addition, the magnetic recording media used in the embodiment are not limited to the magnetic disk, but also can be other magnetic recording media such as magnetic tapes and magnetic cards. Further, the magnetic recording media are not necessarily fixed in the housing 113. It can be portable media that can be loaded/unloaded into/from the housing 113.

This invention is not limited to those described above. This invention can be varied or improved in a variety of ways within the scope of the invention.

What is claimed is:

1. A substrate for a perpendicular magnetic recording medium:
wherein said substrate is of at least one nonmagnetic material, and
an angle of inclination of a surface profile curve of said substrate is 2.0 degree or less, or a surface roughness of said substrate with cycle in the ranges of 83 nm or less to 30 nm or less is 0.15 nm or less.

2. The substrate according to claim 1, wherein:
said surface roughness of said substrate with cycle in the ranges of 59 nm or less to 40 nm or less is 0.15 nm or less.

3. The substrate according to claim 1, wherein:
said surface roughness of said substrate with cycle in the ranges of 50 nm or less is 0.15 nm or less.

4. The substrate according to claim 1, wherein:
said surface of said substrate is processed mechanically in a track direction.

5. The substrate according to claim 2, wherein:
said surface of said substrate is processed mechanically in a track direction.

6. The substrate according to claim 3, wherein:
said surface of said substrate is processed mechanically in a track direction.

7. A perpendicular magnetic recording medium, comprising:
a nonmagnetic substrate; and
a magnetic recording structure formed on a surface of said substrate, the magnetic recording structure having, at least, a soft magnetic underlayer, an intermediate layer and a magnetic layer,
wherein said substrate has a surface profile curve whose angle of inclination is 2.0 degree or less, or whose surface roughness of said substrate with cycle in the ranges of 83 nm or less to 30 nm or less is 0.15 nm or less.

8. The magnetic recording medium according to claim 7, wherein:
said surface roughness of said substrate with cycle in the ranges of 59 nm or less to 40 nm or less is 0.15 nm or less.

9. The magnetic recording media according to claim 7, wherein:
said surface roughness of said substrate with cycle in the ranges of 50 nm or less is 0.15 nm or less.

10. The magnetic recording media according to claim 7, wherein:
the surface of said substrate is processed mechanically a track direction.

11. The magnetic recording media according to claim 8, wherein:
the surface of said substrate is processed mechanically a track direction.

12. The magnetic recording media according to claim 9, wherein:
the surface of said substrate is processed mechanically a track direction.

13. A manufacturing method of a perpendicular magnetic recording medium comprising:
processing mechanically the surface of the substrate made of nonmagnetic material in track direction, cleansing surface of said substrate after said mechanical processing, and
forming a magnetic recording structure on the surface of said substrate, said magnetic recording structure having, at least, a soft magnetic underlayer, an inner layer and a magnetic layer, wherein:
an angle of inclination of a surface profile curve of said substrate is 2.0 degree or less, or a surface roughness of said substrate with cycle in the ranges of 83 nm or less to 30 nm or less is 0.15 nm or less.

14. The manufacturing method of the magnetic recording media according to claim 13, wherein:
the surface roughness of said substrate with cycle in the ranges of 59 nm or less to 40 nm or less is 0.15 nm or less.

15. The manufacturing method of the magnetic recording medium according to claim 13, wherein:
the surface roughness of said substrate with cycle in the ranges of 50 nm or less is 0.15 nm or less.

16. A magnetic storage apparatus, comprising:
a magnetic recording medium;
a magnetic writing head for writing data onto said magnetic recording medium;
a magnetic reading head for reading data recorded onto said magnetic recording medium;
a flexible suspension attached to said magnetic recording/reading head, having a flexibility; and
an actuator arm fixing an end of said suspension, flexibly pivoting,
wherein said perpendicular magnetic recording medium has a nonmagnetic substrate and a magnetic recording structure, said magnetic recording structure having at least a soft magnetic underlayer, an intermediate layer and a magnetic layer formed above said substrate, and
said substrate has a surface profile curve whose angle of inclination is 2.0 degree or less, or whose surface roughness of said substrate with cycle in the ranges of 83 nm or less to 30 nm or less is 0.15 nm or less.

17. The magnetic recording medium according to claim 16, wherein:
the surface roughness of said substrate with cycle in the ranges of 59 nm or less to 40 nm or less is 0.15 nm or less.

18. The magnetic recording media according to claim 16, wherein:
the surface of said substrate is processed mechanically in a track direction.

19. The magnetic recording media according to claim 17, wherein:
the surface of said substrate is processed mechanically in a track direction.
